(19) United States
(12) Patent Application Publication
(10) Pub. No.: US 2011/0218761 A1
(43) Pub. Date: Sep. 8, 2011

(54) ABSOLUTE POSITION MEASURING DEVICE

(75) Inventor: Christoph Lingk, Traunstein (DE)

(73) Assignee: DR JOHANNES HEIDENHAIN GMBH, Traunreut (DE)

(21) Appl. No.: 13/126,605

(22) PCT Filed: Oct. 1, 2009
(86) PCT No.: PCT/EP2009/007043

§ 371 Date: Apr. 28, 2011

(30) Foreign Application Priority Data
Oct. 30, 2008 (DE) 10 2008 053 986.4

(51) Int. Cl. G06F 15/00

(52) U.S. Cl. 702/151

(57) ABSTRACT

An absolute angle coding that includes a first cyclically continued code sequence that cyclically continues a first code sequence a multiple number of times, wherein the first code sequence is disposed within 360° and includes a first succession of code elements that defines a first angle sector. The code further includes a second cyclically continued code sequence that cyclically continues a second code sequence a multiple number of times, wherein the second code sequence is disposed within 360° and includes a second succession of code elements that defines a second angle sector, wherein the first cyclically continued sequence and the second cyclically continued code sequence in combination unambiguously absolutely encode the 360°. The first angle sector is not equal to the second angle sector, and at least one of the second code sequences of the second cyclically continued code sequence is embodied only partially within said 360° and with a succeeding second code sequence forms a joint.

In many fields, absolute angle measuring devices are used to determine the position of two bodies moved relative to one another. Compared to systems that measure purely incrementally, absolute angle measuring devices have the advantage that in every relative position, correct position information can be output immediately, even after the energy supply has been interrupted.

The absolute position is embodied by an angle coding. Disposing the position information in a single code track, with code elements disposed in succession in the measurement direction, is especially space-saving. The code elements are disposed in succession in pseudo-random distribution, so that a certain number of successive code elements each form one code word, which unambiguously defines the absolute position. When the scanning unit is displaced by a single code element, a new code word is already formed, and over the entire range to be detected absolutely, a succession of different code words is available. This kind of serial or sequential code is often also called a chain code or a pseudo-random code (PRC).

For determining the absolute position from the scanned code words—also called decoding—a decoding table is used, in which one position is associated with each code word. For associating the absolute position with a scanned code word, the code word forms the address for the decoding table, so that at the output, the absolute position stored in memory for this code word is present and is available for further processing. These nonvolatile tables can be designed today in hardware-wired fashion in an ASIC, to make fast access possible.

The demands in terms of resolution of angle measuring devices are becoming more and more stringent, so that over 360°, many positions have to be encoded unambiguously. The more positions have to be encoded, the more complex is the ensuing decoding. In serial encoding, it is problematic that for high resolution, a very great number of different code words have to be generated and decoded. If the decoding is done by means of tables, a large table is required, in which for every possible code word, one associated absolute position is stored in memory. If the decoding is done with a computer, the result is relatively long computation times.

U.S. Pat. No. 6,330,522 B1 shows a provision for how an angle coding and an angle measuring device can be designed in order to reduce the complexity of decoding. In it, a first code sequence and a second code sequence are disposed over 360°, in tracks extending parallel to one another. The first code sequence is disposed five times over 360°, and the second code sequence is disposed fourteen times over 360°. The code sequences include different angle sectors. The bit width of the first code sequence differs from the bit width of the second code sequence. The decoder device has a first value set for decoding the first code sequence and a second value set for decoding the second code sequence. The absolute position is unambiguous because of the combination of the two partial positions at every point over 360°.

A disadvantage is that over 360°, only a number of positions that in each case is an integral multiple of the length of the two code sequences can be encoded.

It is therefore the object of the invention to disclose an angle coding with which an arbitrary number of positions over 360° can be unambiguously encoded, and with which in an angle measuring device, simple decoding of the successions of code words, generated by scanning this angle coding, is made possible.

This object is attained by the angle coding recited in claim 1.

In claim 12, an absolute angle measuring device with an angle coding of this kind is recited.

The absolute angle coding has a plurality of code sequences that are disposed within 360° and that in combination unambiguously absolutely encode the 360°, of which

a first code sequence, comprising a succession of code elements, includes a first angle sector and is disposed in multiple succession and is also cyclically continued multiple times;

a second code sequence, comprising a succession of code elements, includes a second angle sector and is disposed in multiple succession and is also cyclically continued multiple times, wherein

the first angle sector is not equal to the second angle sector, and at least one of the code sequences is embodied only partially within the 360° and with the succeeding code sequence forms a joint.

In other words, at least one of the two code sequences is plotted only partly once within 360°, and this part is connected to the next code sequence. At this connection point, this code sequence is interrupted, since a joint region occurs here, at which in the scanning a new succession of code elements, that is, new bit patterns or words, occurs. “New bit patterns” means that these bit patterns are not a component of the code sequences or of their cyclical continuations.

The code sequences are disposed in circular fashion on a disk or over the circumference of a drum.

Each code element is a respective region of the angle coding from which a bit can be derived.

Code sequence means a succession of code elements that defines different positions, over the total length of the code sequence, in the grid of a code element.

The term cyclically continued code sequence means that at the end of the code sequence, the beginning of this same code sequence ensues again.

The angle coding embodied according to the invention now makes it possible in particular to encode 2^{k} different positions over 360°, where preferably k is greater than 4 and is an integer.

The code elements of the first code sequence and of the second code sequence each include identical angle sectors. On this condition, the size of an angle sector can be defined especially simply by the number of code elements.

The maximum number of different positions is obtained if the length of the first code sequence differs by 1 from the length of the second code sequence. The length of the first code sequence is the number of code elements of the first code sequence, and the length of the second code sequence is the number of code elements of the second code sequence.

Relatively simple evaluation of the words (bit patterns) obtained by scanning the code sequences results if the first code sequence and the second code sequence are disposed in different tracks.

With the disposition in two tracks, in both tracks over 360° each, the same number

M₁<KGV (L_{A}, L_{B}) of code elements is disposed, in which
KGV (L_{A}, L_{B})=least common multiple of L_{A} and L_{B}
L_{A}=integral number of code elements of the first code sequence
L_{B}=integral number of code elements of the second code sequence.

Over the 360°, more different positions can be encoded if the first code sequence and the second code sequence are disposed in the same track, in that one part of the first code sequence and one part of the second code sequence are disposed in alternation. In particular, a code element of the first code sequence is followed by a single code element of the second code sequence in each case, and a code element of the second code sequence is followed in each case by a single code element of the first code sequence.

With the disposition in the same track, in this track over 360° a number

M₂<2*KGV (L_{A}, L_{B}) of code elements is disposed, in which
KGV (L_{A}, L_{B})=least common multiple of L_{A} and L_{B}
L_{A}=integral number of code elements of the first code sequence
L_{B}=integral number of code elements of the second code sequence.

If the position value ascertained by the two code sequences A, B is to be resolved further, at least one incremental track can be disposed concentrically with the absolute angle coding. The graduation period of this incremental track is for instance a fraction of the width of one code element of the code sequences A, B.

An angle measuring device now has a detector array for scanning the first and second code sequences of the angle coding and for generating code words, and also has a decoder device for decoding the code words and for generating position values.

The decoder device has a first value set for decoding a first succession of code words, which each occur upon the scanning of one of the first code sequences as well as its cyclical continuation, and a second value set for decoding a second succession of code words, which each occur upon the scanning of one of the second code sequences as well as its cyclical continuation, and the decoder device has a further value set, which is suitable for decoding the joint of the first code sequence and/or of the second code sequence.

Further advantageous features of the invention are recited in the dependent claims.

Exemplary embodiments of the invention will be described in further detail in conjunction with the drawings.

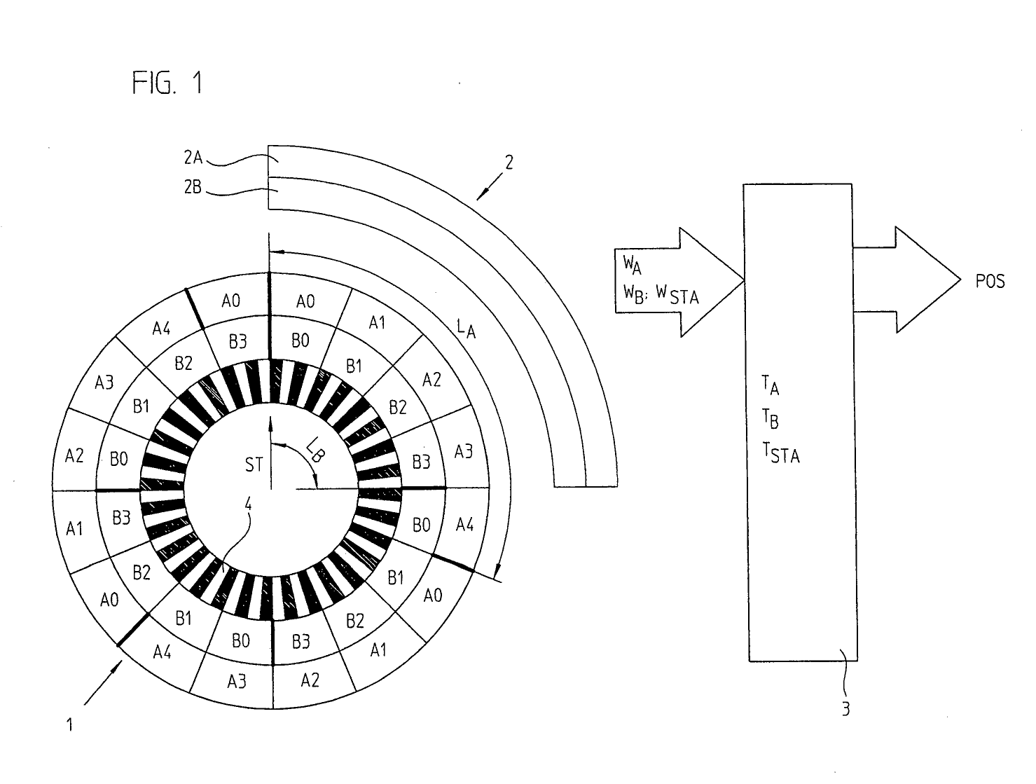

FIG. 1 shows a first angle measuring device with a first angle coding in a schematic illustration;

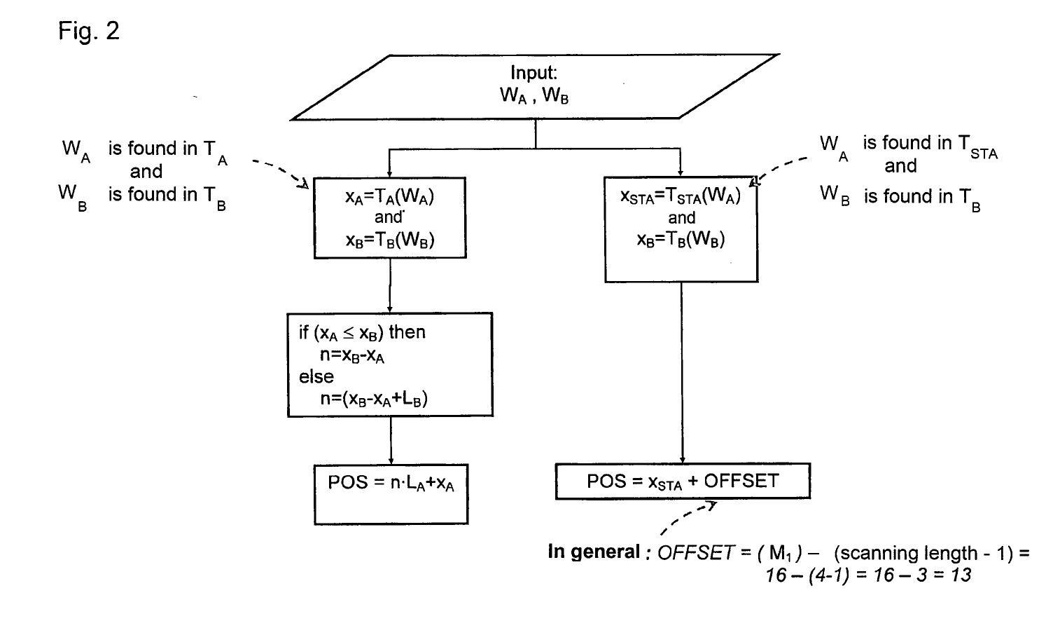

FIG. 2 is a flow chart with algorithms for ascertaining the position of the first angle measuring device;

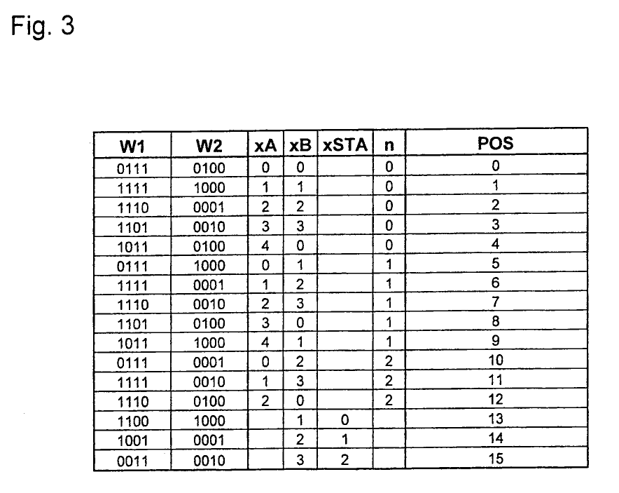

FIG. 3 is a graph showing the position of read-out bit patterns (words) based on an example of the first angle coding;

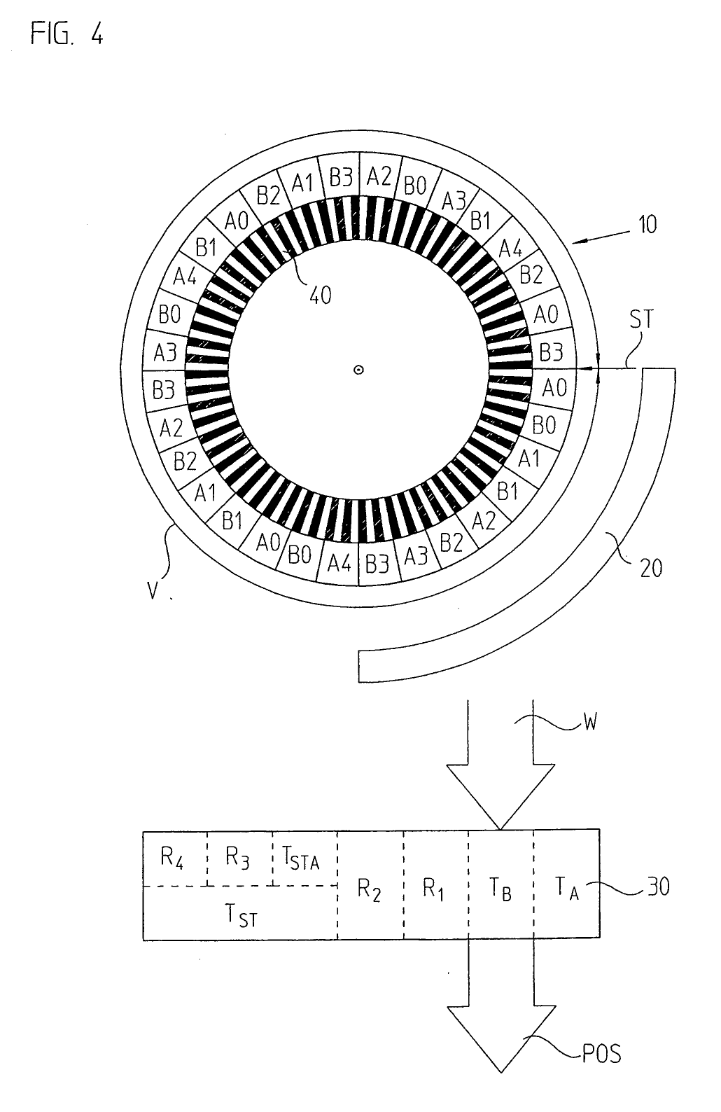

FIG. 4 shows a second angle measuring device with a second angle coding in a schematic illustration;

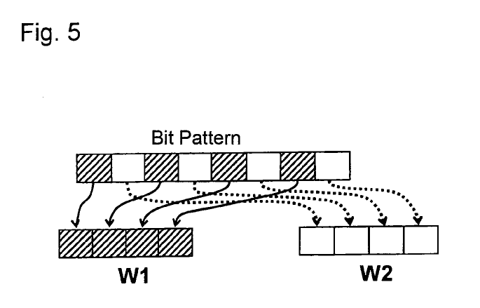

FIG. 5 shows a bit pattern of the detector array of the second angle measuring device;

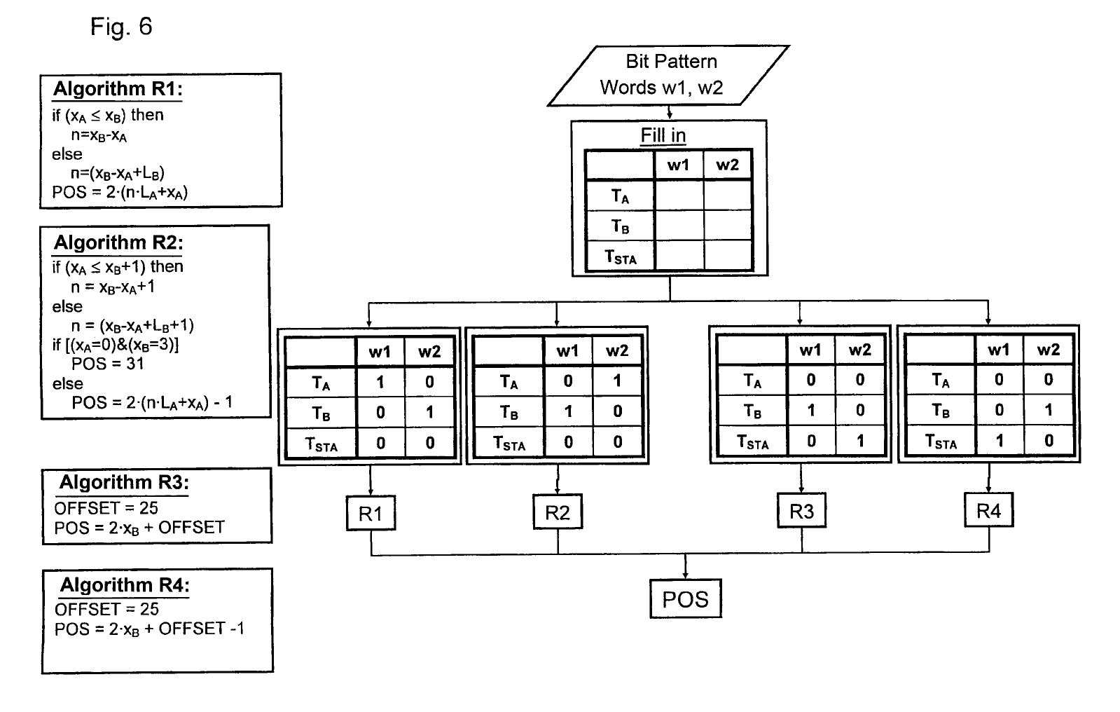

FIG. 6 is a flow chart with algorithms for ascertaining the position of the second angle measuring device; and

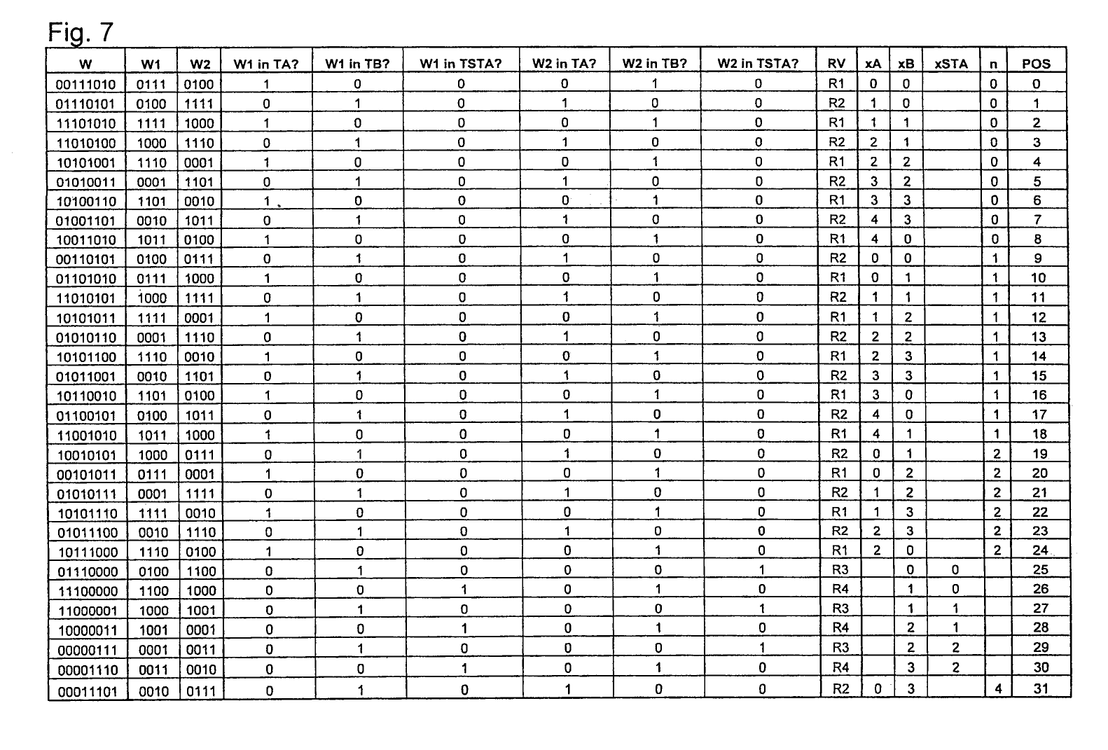

FIG. 7 is a graph showing the position of read-out bit patterns (words) based on an example of the second angle coding.

In the invention, the Nonius principle is employed. For absolute position measurement, two serial code sequences A, B are used, which include different angle sectors L_{A} and L_{B}. At each position within the measurement range of 360°, the unambiguous absolute position POS is now obtained from the combination of partial positions x_{A}, x_{B} of the plurality of serial code sequences A, B. The advantage of such encoding is that a decoder device 3 has to decode only the relatively short plurality of serial code sequences A, B and their cyclical continuations, and then the unambiguous position POS can be ascertained over 360° by relatively simple relations from these decoded code sequences A, B. If the decoding is done by means of tables, only several small tables are required. This requires far fewer table entries than the number of absolute positions that can be output.

In FIG. 1, a first absolute angle coding 1 and angle measuring device embodied according to the invention are shown schematically. The angle coding 1 is embodied such that within one complete revolution, that is, endlessly over 360°, it defines one unambiguous absolute position POS at every position. To that end, the angle coding 1 comprises a succession, disposed one after the other, of code elements A0 through A4 and B0 through B3, which each include one angle sector of the same size. The first succession of code elements A0 through A4 is disposed in a first track and forms the first code sequence A, and the second succession of code elements B0 through B3 is disposed in a second track and forms the second code sequence B. The two code tracks are disposed concentrically to one another. It is especially advantageous if the code elements of the two code tracks are aligned with one another.

The principle of position measurement is based on the shifting of two code sequences A, B of different sizes of the angle sector L_{A} and L_{B} including them. The size of the angle sectors L_{A} and L_{B} differ only slightly from one another for the purpose, so that the angle sector L_{A} is not an integral multiple of the angle sector L_{B}.

If, as is shown in the example, the angle sectors of the code elements A0 through A4 are equal to the angle sectors of the code elements B0 through B3, then for simplified further explanation, the size of the angle sectors of the code sequences A, B can be represented by the number of code elements. Thus L_{A} and L_{B}, as the number of code elements, are integers and are preferably relatively prime. The maximum length M₁ₘₐₓ to be decoded occurs when L_{A} differs by 1 from L_{B}.

The first code sequence A is defined by the bit sequence

A₀, A₁, A₂, A₃ . . . A_{LA-1} of length L_{A}.

The second code sequence B is defined by the bit sequence

B₀, B₁, B₂, B₃ . . . B_{LB-1} of length L_{B}.

### Here, Aᵢ, Bᵢε{0;1}.

Because of the different lengths L_{A}, L_{B} of the code sequence A and the code sequence B, the result is a shift between the code sequences A and B. The total encodable length M₁ₘₐₓ (that is, the length after which the bit pattern repeats) is defined, when L_{A}−L_{B}=1, by

M₁ₘₐₓ=KGV(L_{A},L_{B})=L_{A}*L_{B},

where KGV (L_{A}, L_{B})=the least common multiple of L_{A} and L_{B}.

For many applications, an angle coding 1 that over one revolution, that is, within 360°, defines M₁=2^{k} different positions is desirable. For forming this angle coding 1, at least one of the code sequences A, B within the 360° is therefore not embodied completely, in order to define the desired M₁=2^{k} different positions.

For the position measurement, the angle coding 1 is scanned, for instance optically, in that the code elements modulate a beam of light as a function of position, so that at the location of a detector array 2 of a scanning device, a position-dependent distribution of light occurs that is converted by the detector array 2 into electrical scanning signals w. The detector array 2 is a line sensor, with a succession of detector elements disposed in the measurement direction. The detector elements are embodied such that at least one of the detector elements is unambiguously associated with each of the code elements in each relative position, and thus from each of the code elements, one bit, 0 or 1, can be obtained. To that end, in the case of the optical scanning principle, the code elements are reflective or nonreflective, or opaque or nonopaque, and the reflective code elements are for instance assigned the bit value 1 while the nonreflective code elements are assigned the bit value 0. The succession of these bits (bit pattern) within one code sequence A, B, whose number is dependent on the scanning length L_{L}, forms one code word w for each of the two code sequences A, B. The scanning signals, that is, the code words w, are delivered to a decoder device 3, which from each of the code words w of one of the code sequences A, B derives a partial position x_{A}, x₁₃, and from these partial positions x_{A}, x_{B}, then forms an absolute position POS therefrom. When the detector array 2 is displaced relative to the angle coding 1 by the width or length of one code element A, B, one new code word w is generated from each of the code sequences A, B.

The detector array 2 has one detector 2A, 2B each for scanning a respective one of the code sequences A, B, each with a scanning length L_{L1}. For this angle coding there are now two ranges:

### First Range:

This is the range in which all the code sequences A, B are embodied completely and are present in cyclically continued form.

### Second Range:

The result is a new joint ST, at which the cyclical continuation of at least one of the code sequences (in this case the code sequence A) is interrupted. This range over this joint ST dictates separate treatment in the decoding, with at least one separate table, because the bit patterns generated in the scanning over this joint ST are not present in the tables T_{A} and/or T_{B}.

Further explanations will be made below in terms of one example:

Number of bits required per circumference: M₁=16=2⁴
Scanning length: L_{L1}=4

### L_{A}=5

### L_{B}=4

The full angle coding 1 has a length=L_{A}*L_{B}=20 positions, and for creating the required angle coding 1 it is cut or reduced to a length M₁ of 16 positions.

The code sequences A and B are defined by the following:

Code sequence A: A₀A₁A₂A₃A₄
Code sequence B: B₀B₁B₂B₃

TABLE T_{A}
For code sequence A

| Bit Pattern | Word W_{A} | Partial Position x_{A} |
|---|---|---|
| A₀A₁A₂A₃ | W_{A0} | 0 |
| A₁A₂A₃A₄ | W_{A1} | 1 |
| A₂A₃A₄A₀ | W_{A2} | 2 |
| A₃A₄A₀A₁ | W_{A3} | 3 |
| A₄A₀A₁A₂ | W_{A4} | 4 |

TABLE T_{B}
For code sequence B

| Bit Pattern | Word W_{B} | Partial Position x_{B} |
|---|---|---|
| B₀B₁B₂B₃ | W_{B0} | 0 |
| B₁B₂B₃B₀ | W_{B1} | 1 |
| B₂B₃B₀B₁ | W_{B2} | 2 |
| B₃B₀B₁B₂ | W_{B3} | 3 |

Now, what happens to the code sequences A and B at the new joint ST?

First, one can see that the code sequence B was cut off precisely at its cyclical continuation (that is, between B₃ and B₀). Thus if the detector array 20 moves past the joint ST, no problems arise with the code sequence B (“B grid”) and with the table T_{B}: the bit B₃ is followed again by the bit B₀. The code sequence B and its cyclical continuation are accordingly not interrupted.

Conversely, the code sequence A is interrupted at the joint ST, since at the joint, one of the code sequences A is cut off and is not plotted completely. For the code sequence A, as the detector array 2A passes over the joint ST, new bit patterns now occur, which do not occur in the table T_{A}. The bit A₀ is in fact not followed by A₁ but rather by A₀ again and only then by Aₗ. The new positions of the code sequence A at the joint ST are summarized in a new table T_{STA} (“ST” stands for joint; “A” stands for code sequence A). This additional table T_{STA} makes the value set for decoding the words W_{STA}, generated by the detector 2A at the abutment ST available. The number of entries is 3 (L_{L1}−1) in this example.

TABLE T_{STA}

| Bit Pattern | Word W_{STA} | Partial Position x_{STA} |
|---|---|---|
| A₃A₄A₀A₀ | W_{STA0} | 0 |
| A₄A₀A₀A₁ | W_{STA1} | 1 |
| A₀A₀A₁A₂ | W_{STA2} | 2 |

The position POS is now ascertained, outside the abutment ST, from the partial positions x_{A} and x_{B} and, on the pass over the abutment ST, from the partial positions x_{A} and X_{STA}.

The invention will now be still further explained on the basis of a concrete angle coding:

The code sequences A and B are defined by the following:
Code sequence A: 01111
Code sequence B: 0100
Maximum encodable length=KGV(5;4)=20
Complete track with the code sequence A:
01111011110111101111
Complete track with the code sequence B:
01000100010001000100
Track of code sequence A reduced to 16 positions:
0111101111011110
Track of code sequence B reduced to 16 positions:
0100010001000100
Scanning length L_{L}=4 (for each of the two tracks)

TABLE T_{A}
For code sequence A

| Bit Pattern | Word W_{A} | Partial Position x_{A} |
|---|---|---|
| 0111 | W_{A0} | 0 |
| 1111 | W_{A1} | 1 |
| 1110 | W_{A2} | 2 |
| 1101 | W_{A3} | 3 |
| 1011 | W_{A4} | 4 |

TABLE T_{B}
For code sequence B

| Bit Pattern | Word W_{B} | Partial Position_{B} |
|---|---|---|
| 0100 | W_{B0} | 0 |
| 1000 | W_{B1} | 1 |
| 0001 | W_{B2} | 2 |
| 0010 | W_{B3} | 3 |

TABLE T_{STA}

| Bit Pattern | Word W_{STA} | Partial Position_{STA} |
|---|---|---|
| 1100 | W_{STA0} | 0 |
| 1001 | W_{STA1} | 1 |
| 0011 | W_{STA2} | 2 |

A flow chart and algorithms for ascertaining the position POS from read-out bit patterns is shown in FIG. 2.

FIG. 3 shows a graph for ascertaining the position POS from the read-out bit patterns (words) on the basis of the concrete example.

If the position measurement value ascertained from the two code sequences A, B is to be resolved further, then the above-described angle coding 1 can be expanded by one further track or a plurality of further tracks with absolute codes or with incremental graduations.

It is especially advantageous, from the absolute angle coding 1, to derive a periodic incremental signal which has a period corresponding to the width (angle sector) or an integral multiple of the width of one code element.

Additionally, it is advantageous to dispose an incremental track 4 parallel, that is, concentrically, to the tracks having the code sequences A, B. The graduation period of this incremental track 4 is advantageously a fraction of the width of one code element of the code sequences A, B. Within one angle sector of one code element, a number greater than or equal to 1 of incremental graduation periods is advantageously disposed. This dimensioning of the incremental track 4 makes it possible to further subdivide the width of one code element. To that end, the incremental graduation 4 is scanned by means of a further detector unit, not shown, which in a known manner generates a plurality of incremental signals phase-offset from one another. These incremental signals are delivered to an interpolator, which further subdivides the incremental signals and outputs an absolute partial position within the width of one code element. The absolute position POS obtained from the absolute angle coding 1 and the partial position obtained from the incremental track 4 are delivered to a combination unit, which from them forms a total position, which over the measurement range of 360° is absolute and thus unambiguous and has a resolution corresponding to the interpolation step ascertained from the incremental graduation. For example, 2¹¹ code elements and one incremental graduation with 2¹⁵ incremental periods are disposed over 360°. In that case, within one code element there are 16 incremental periods.

A second exemplary embodiment of the invention will now be described in conjunction with FIGS. 4 through 7. The angle coding 10 is then produced by the alternation disposition of one code element (bit) from the code sequence A and then one code element (bit) from the code sequence B:

$$\vert {{{A}_{0} {B}_{0} {A}_{1} {B}_{1} {A}_{2} {B}_{2} … {A}_{LA - 1} {B}_{LB - 1}}_{}}_{{M}_{2 max} = 2 * {L}_{A} * {L}_{B}} \vert {A}_{0} {B}_{0} …$$

Because of the different lengths L_{A}, L_{B} of the code sequence A and the code sequence B, the result is a shift between the code sequences A and B.

The total encodable length M₂ₘₐₓ (that is, the length after which the bit pattern repeats) is defined, when L_{A}−L_{B}=1, by

M₂ₘₐₓ=2*KGV(L_{A},L_{B})=2*L_{A}*L_{B},

where KGV (L_{A}, L_{B})=the least common multiple of L_{A} and L_{B}.

Once again, for forming the angle coding 10, at least one of the code sequences A, B is embodied as not complete within the 360°, in order for instance to define the required M₂=2^{k} different positions. Once again, the angle coding 10 is defined by the lengths L_{A} and L_{B} of the code sequences A and B, where L_{A} is not equal to L_{B}, and L_{A} and L_{B} are integers. Since the code elements all include the same angle sector, the lengths L_{A} and L_{B} are again defined as a number of code elements of the corresponding code sequences A, B.

A detector array 20 with a scanning length L_{L2} will now also be assumed, with L_{L2} being an even number. For this system, there are now two ranges:

First Range: Positions 0 . . . to (M₂−L_{L2}):

This is the range in which for the angle coding 10, only complete code sequences A and B are present over 360°. The total position POS is calculated here by means of the algorithms R₁ and R₂ in accordance with FIG. 6.

### Second Range Positions (M₂−L_{L2}+1) . . . to (M₂−1):

At the joint ST, at least one of the code sequences A, B is cut off, and thus the cyclical continuation of at least one of the code sequences (in this case the code sequence A) is interrupted. This range over this joint ST dictates special treatment with at least one special table, since the bit patterns generated in the scanning over this joint ST are not present in the tables T_{A} and/or T_{B}.

Further explanations will be made below in terms of one example:

Number of bits required per circumference: M₂=32=2⁵
Scanning length: L_{L2}=8

### L_{A}=5

### L_{B}=4

The full angle coding 1 has a length

M₂ₘₐₓ=2*L_{A}*L_{B}

In the example, it thus has 40 positions, and to create the requisite angle coding 10 it is cut off or reduced to a length M₂ of 32 positions.

The code sequences A and B are defined by the following:

Code sequence A: A₀A₁A₂A₃A₄
Code sequence B: B₀B₁B₂B₃
The tables T_{A} and T_{B} are then defined as follows:

TABLE T_{A}
for code sequence A

| Bit Pattern | Word w | Partial Position x_{A} |
|---|---|---|
| A₀A₁A₂A₃ | W_{A0} | 0 |
| A₁A₂A₃A₄ | W_{A1} | 1 |
| A₂A₃A₄A₀ | W_{A2} | 2 |
| A₃A₄A₀A₁ | W_{A3} | 3 |
| A₄A₀A₁A₂ | W_{A4} | 4 |

TABLE T_{B}

| Bit Pattern | Word w | Partial Position x_{B} |
|---|---|---|
| B₀B₁B₂B₃ | W_{B0} | 0 |
| B₁B₂B₃B₀ | W_{B1} | 1 |
| B₂B₃B₀B₁ | W_{B2} | 2 |
| B₃B₀B₁B₂ | W_{B3} | 3 |

Now, what happens to the code sequences A and B at the new joint ST?

First, one can see that the code sequence B was cut off precisely at its cyclical continuation (that is, between B₃ and B₀). Thus if the detector array 20 moves past the joint ST, no problems arise with the code sequence B (“B grid”) and with the table T_{B}: the bit B₃ is followed again by the bit B₀. The code sequence B and its cyclical continuation are accordingly not interrupted.

Conversely, the code sequence A is interrupted at the joint ST, since at the joint ST. For the code sequence A, as the detector array 20 passes over the joint ST, new bit patterns now occur, which do not occur in the table T_{A}. The bit A₀ is in fact not followed by A₁ but rather by A₀ again and only then by A₁. The new positions of the code sequence A at the joint ST can be summarized in a new table T_{STA} (“ST” stands for joint; “A” stands for code sequence A).

TABLE T_{STA}

| Bit Pattern | Word w | Partial Position x_{STA} |
|---|---|---|
| A₃A₄A₀A₀ | W_{STA0} | 0 |
| A₄A₀A₀A₁ | W_{STA1} | 1 |
| A₀A₀A₁A₂ | W_{STA2} | 2 |

The algorithms R1, R2, R3 and R4 for ascertaining the position POS are shown in FIG. 6. It should be noted that these algorithms R1, R2, R3 and R4 are given only as examples, since still other relations may be used here as well.

Another possibility for ascertaining the positions POS_{ST} at the joint ST is to look at the successive bit patterns in their entirety. To that end, the (L_{L2}−1)=7 bit patterns of the joint ST are written into a table T_{ST}, in which the word length in this table T_{ST} is now L_{L2}, or in the example, 8.

TABLE T_{ST}

| Bit Pattern | Word w | Position x_{ST} |
|---|---|---|
| B₀A₃B₁A₄B₂A₀B₃A₀ | W_{ST0} | 25 |
| A₃B₁A₄B₂A₀B₃A₀B₀ | W_{ST1} | 26 |
| B₁A₄B₂A₀B₃A₀B₀A₁ | W_{ST2} | 27 |
| A₄B₂A₀B₃A₀B₀A₁B | W_{ST3} | 28 |
| B₂A₀B₃A₀B₀A₁B₁A₂ | W_{ST4} | 29 |
| A₀B₃A₀B₀A₁B₁A₂B₂ | W_{ST5} | 30 |
| B₃A₀B₀A₁B₁A₂B₂A₃ | W_{ST6} | 31 |

Finally, for the above example, one code in the associated tables will also be given:

Code sequence A: 01111
Code sequence B: 0100
Complete angle coding (length, 40 bits):
0011101010011010101100101011100010111010
Angle coding 10 (32-bit excerpt from the complete angle coding with 40 bits):
00111010100110101011001010111000

TABLE T_{A}
for code sequence A

| Bit Pattern | Word w | Partial Position x_{A} |
|---|---|---|
| 0111 | W_{A0} | 0 |
| 1111 | W_{A1} | 1 |
| 1110 | W_{A2} | 2 |
| 1101 | W_{A3} | 3 |
| 1011 | W_{A4} | 4 |

TABLE T_{B}
for code sequence B

| Bit Pattern | Word w | Partial Position x_{B} |
|---|---|---|
| 0100 | W_{B0} | 0 |
| 1000 | W_{B1} | 1 |
| 0001 | W_{B2} | 2 |
| 0010 | W_{B3} | 3 |

TABLE T_{STA}

| Bit Pattern | Word w | Partial Position x_{STA} |
|---|---|---|
| 1100 | W_{STA0} | 0 |
| 1001 | W_{STA1} | 1 |
| 0011 | W_{STA2} | 2 |

TABLE T_{ST}

| Bit Pattern | Word w | Partial Position x_{ST} |
|---|---|---|
| 01110000 | W_{ST0} | 25 |
| 11100000 | W_{ST1} | 26 |
| 11000001 | W_{ST2} | 27 |
| 10000011 | W_{ST3} | 28 |
| 00000111 | W_{ST4} | 29 |
| 00001110 | W_{ST5} | 30 |
| 00011101 | W_{ST6} | 31 |

From both examples, one can see that it is especially advantageous if one of the code sequence lengths (L_{A} or L_{B}) is already a power of two. In the second example above, the total length is M₂=32 and L_{B}=4. The advantage here is then that only one of the code sequences A or B (specifically only code sequence A) has to be “cut off”. In the other code sequence (in this case the code sequence B), all the code sequences as well as their cyclical continuations are kept complete in their entirety over 360°.

For the number of code elements within 360°, for the second example, the following then applies:

M₂=2*(KGV(L_{A},L_{B})−E*L_{A}),

which means that only one of the code sequences B is incomplete, or

M₂=2*(KGV(L_{A},L_{B})−E*L_{B}),

which means that only one of the code sequences A is incomplete,
and E is an integer >0.

In the example explained above with L_{A}=5 and L_{B}=4 and E=1, one of the code sequences A is incomplete, and M₂=32.

In FIG. 7, a graph is shown for ascertaining the position POS from read-out bit patterns (words) w based on the example of the second angle coding 10. In the second and third columns, the words w1 and w2 ascertained from the words w of FIG. 5 are shown. The six further columns show the question of whether the words w 1 or w2 have been found in the tables T_{A}, T_{B}, T_{STA}. A “1” defines “found”. The next column marked “RV” defines the algorithm R1, R2, R3 or R4 to be used. In the following three columns, the partial positions x_{A}, x_{B} and x_{STA} are given. The next column contains the value “n” calculated by the rules given in FIG. 6. The last column now contains the position POS calculated in accordance with the corresponding algorithms R1, R2, R3, and R4.

The decoder device 3, 30 is advantageously embodied as an ASIC, and the required tables T, that is, the value sets required, are each hard-wired in the production of the ASIC. Alternatively, the tables T or value sets could instead be stored in memory in read-only memories, such as EPROMs.

In the angle measuring devices embodied according to the invention, a mixed form of memories is especially advantageous; on the one hand, fast access to the memory data, that is, the value sets, is attained, and on the other, rapid adaptation to the intended use is made possible. This is attained on the one hand because the value set T_{A}, T_{B} for the code sequences A and B and their cyclical continuations is embodied in hard-wired form, and in addition, a memory that is also programmable after the mask production is provided, and the individually required value set T_{ST}, T_{STA} of the abutment ST is stored in this programmable memory, in other words, in the tables T_{ST} and T_{STA}, respectively. The programmable memory is a read-only memory and is embodied for instance as an EPROM.

The tables T_{ST} and T_{STA} can be fixedly defined or in other words stored in memory during the production of the angle measuring device. Alternatively, the tables T_{ST} and T_{STA} can be generated automatically and stored in memory by means of a specified formation rule, or they are generated by means of a calibration run, in which one position is associated with each scanned bit pattern (word) and stored in memory.

As shown schematically in FIG. 4, the absolute angle coding 10 in the example of FIG. 1 can be expanded with an incremental graduation 40. Once again within one angle sector of one code element, a number, advantageously equal to or greater than 1, of incremental graduation periods is disposed.

The invention can be especially advantageously used on the optical scanning principle, since an optically scannable angle coding 1, 10 with a maximum number of possible different positions over 360° (one revolution of the angle coding 1, 10) can be produced replicably, and thus especially high-resolution position measurement is made possible. The detector array 2, 20 and the decoder device 3, 30 can be accommodated jointly in an opto-ASIC.

However, the invention is not limited to the optical scanning principle, but can also be used with magnetic, inductive and capacitive scanning principles.

1-14. (canceled)

15. An absolute angle coding comprising:
a first cyclically continued code sequence that cyclically continues a first code sequence a multiple number of times, wherein said first code sequence is disposed within 360° and comprises a first succession of code elements that defines a first angle sector; and
a second cyclically continued code sequence that cyclically continues a second code sequence a multiple number of times, wherein said second code sequence is disposed within 360° and comprises a second succession of code elements that defines a second angle sector, wherein said first cyclically continued sequence and said second cyclically continued code sequence in combination unambiguously absolutely encode said 360° and
wherein said first angle sector is not equal to said second angle sector, and at least one of said second code sequences of said second cyclically continued code sequence is embodied only partially within said 360° and with a succeeding second code sequence forms a joint.

16. The absolute angle coding as defined by claim 15, wherein each of said code elements of said first code sequence define a third angle sector and each of said code elements of said second code sequence define a fourth angle sector, wherein said third angle sector and said fourth angle sector are identical.

17. The absolute angle coding as defined by claim 16, wherein a total integral number of code elements of said first code sequence is defined to be a first length and a total integral number of code elements of said second code sequence is defined to be a second length, wherein said first length differs by one code element from said second length.

18. The absolute angle coding as defined by claim 15, wherein said first code sequence is disposed in a first track, and said second code sequence is disposed in a second track, which extends concentrically with respect to said first track.

19. The absolute angle coding as defined by claim 16, wherein said first code sequence is disposed in a first track, and said second code sequence is disposed in a second track, which extends concentrically with respect to said first track.

20. The absolute angle coding as defined by claim 17, wherein said first code sequence is disposed in a first track, and said second code sequence is disposed in a second track, which extends concentrically with respect to said first track.

21. The absolute angle coding as defined by claim 19, wherein over 360°, in both said first track and said second track a same number of
M₁<KGV of code elements are disposed, in which
KGV=least common multiple of L_{A} and L_{B}, wherein
L_{A}=integral number of code elements of said first code sequence; and
L_{B}=integral number of code elements of said second code sequence.

22. The absolute angle coding as defined by claim 20, wherein over 360°, in both said first track and said second track a same number of
M₁<KGV of code elements are disposed, in which
KGV=least common multiple of L_{A} and L_{B}, wherein
L_{A}=integral number of code elements of said first code sequence; and
L_{B}=integral number of code elements of said second code sequence.

23. The absolute angle coding as defined by claim 21, wherein M₁=2^{k}, wherein k is greater than 4 and is an integer.

24. The absolute angle coding as defined by claim 22, wherein M₁=2^{k}, wherein k is greater than 4 and is an integer.

25. The absolute angle coding as defined by claim 15, wherein said first cyclically continued code sequence and said second cyclically continued code sequence are disposed in a common track, in that one part of said first cyclically continued code sequence and said second cyclically continued code sequence are each disposed in alternation relative to one another.

26. The absolute angle coding as defined by claim 25, wherein over 360°, a number of
M₂<2*KGV of code elements is disposed, in which
KGV=least common multiple of L_{A} and L_{B}, wherein
L_{A}=integral number of code elements of said first code sequence; and
L_{B}=integral number of code elements of said second code sequence.

27. The absolute angle coding as defined by claim 26, wherein M₂=2^{k}, wherein k is greater than 4 and is an integer.

28. An absolute angle measuring device, comprising:
an absolute angle coding comprising:
a first cyclically continued code sequence that cyclically continues a first code sequence a multiple number of times, wherein said first code sequence is disposed within 360° and comprises a first succession of code elements that defines a first angle sector; and
a second cyclically continued code sequence that cyclically continues a second code sequence a multiple number of times, wherein said second code sequence is disposed within 360° and comprises a second succession of code elements that defines a second angle sector, wherein said first cyclically continued sequence and said second cyclically continued code sequence in combination unambiguously absolutely encode said 360° and
wherein said first angle sector is not equal to said second angle sector, and at least one of said second code sequences of said second cyclically continued code sequence is embodied only partially within said 360° and with a succeeding second code sequence forms a joint;
a detector array for scanning said first and second code sequences and for generating code words; and
a decoder device for decoding said code words and for generating position values.

29. The absolute angle measuring device as defined by claim 28, wherein said decoder device comprises a first value set for decoding a first succession of code words, which each of said first succession of code words occur upon scanning of one of said first code sequences as well as said first cyclical continued code sequence; and
said decoder device comprises a second value set for decoding a second succession of code words, which each of said second succession of code words occur upon scanning of one of said second code sequences as well as said first cyclical continued code sequence; and
said decoder device comprises a third value set, which is suitable for decoding said joint.

30. The absolute angle measuring device as defined by claim 29, wherein said third value set is stored in a programmable read-only memory, and said first value set and said second value set are both present in hard-wired form.

31. The absolute angle measuring device as defined by claim 28, wherein each of said code elements of said first code sequence define a third angle sector and each of said code elements of said second code sequence define a fourth angle sector, wherein said third angle sector and said fourth angle sector are identical.

32. The absolute angle measuring device as defined by claim 31, wherein a total integral number of code elements of said first code sequence is defined to be a first length and a total integral number of code elements of said second code sequence is defined to be a second length, wherein said first length differs by one code element from said second length.

33. The absolute angle measuring device as defined by claim 28, wherein said first code sequence is disposed in a first track, and said second code sequence is disposed in a second track, which extends concentrically with respect to said first track.

34. The absolute angle measuring device as defined by claim 29, wherein said first code sequence is disposed in a first track, and said second code sequence is disposed in a second track, which extends concentrically with respect to said first track.

35. The absolute angle measuring device as defined by claim 30, wherein said first code sequence is disposed in a first track, and said second code sequence is disposed in a second track, which extends concentrically with respect to said first track.

36. The absolute angle measuring device as defined by claim 34, wherein over 360°, in both said first track and said second track a same number of
M₁<KGV of code elements are disposed, in which
KGV=least common multiple of L_{A} and L_{B}, wherein
L_{A}=integral number of code elements of said first code sequence; and
L_{B}=integral number of code elements of said second code sequence.

37. The absolute angle measuring device as defined by claim 35, wherein over 360°, in both said first track and said second track a same number of
M₁<KGV of code elements are disposed, in which
KGV=least common multiple of L_{A} and L_{B}, wherein
L_{A}=integral number of code elements of said first code sequence; and
L_{B}=integral number of code elements of said second code sequence.

38. The absolute angle measuring device as defined by claim 36, wherein M₁=2^{k}, wherein k is greater than 4 and is an integer.

39. The absolute angle measuring device as defined by claim 37, wherein M₁=2^{k}, wherein k is greater than 4 and is an integer.

40. The absolute angle measuring device as defined by claim 28, wherein said first cyclically continued code sequence and said second cyclically continued code sequence are disposed in a common track, in that one part of said first cyclically continued code sequence and said second cyclically continued code sequence are each disposed in alternation relative to one another.

41. The absolute angle measuring device as defined by claim 40, wherein over 360°, a number of
M₂<2*KGV of code elements is disposed, in which
KGV=least common multiple of L_{A} and L_{B}, wherein
L_{A}=integral number of code elements of said first code sequence; and
L_{B}=integral number of code elements of said second code sequence.

42. The absolute angle measuring device as defined by claim 41, wherein M₂=2^{k}, wherein k is greater than 4 and is an integer.

43. The absolute angle measuring device as defined by claim 28, further comprising an incremental track disposed concentrically to said absolute angle coding.

44. The absolute angle measuring device as defined by claim 43, wherein within one code element, a whole number equal to or greater than 1 of incremental graduation periods is disposed.
